(19) United States
(12) Patent Application Publication
(10) Pub. No.: US 2014/0297613 A1
(43) Pub. Date: Oct. 2, 2014

(54) METHOD FOR CUSTOMIZING SEARCH QUERIES TO OPTIMIZED SEARCH RESULTS

(71) Applicant: Doat Media Ltd., Tel Aviv (IL)

(72) Inventors: Rami KASTERSTEIN, Givataim (IL); Amihay BEN-DAVID, London (GB); Joey Joseph SIMHON, Ramat-Gan (IL)

(73) Assignee: Doat Media Ltd., Tel Aviv (IL)

(21) Appl. No.: 14/301,807

(22) Filed: Jun. 11, 2014

Related U.S. Application Data
(63) Continuation-in-part of application No. 13/474,404, filed on May 17, 2012.
Application No. 13/474,404 is a continuation-in-part of application No. 13/156,999, filed on Jun. 9, 2011.
Application No. 13/156,999 is a continuation-in-part of application No. 13/712,563, filed on Dec. 12, 2012.
Application No. 13/712,563 is a continuation-in-part of application No. 13/156,999, filed on Jun. 9, 2011.
Application No. 13/712,563 is a continuation-in-part of application No. 13/296,619, filed on Nov. 15, 2011.
Application No. 13/296,619 is a continuation-in-part of application No. 13/156,999, filed on Jun. 9, 2011.
Application No. 13/156,999 is a continuation-in-part of application No. 13/296,619, filed on Nov. 15, 2011.
Application No. 13/296,619 is a continuation-in-part of application No. 14/103,536, filed on Dec. 11, 2013.
Application No. 14/103,536 is a continuation-in-part of application No. 13/712,563, filed on Dec. 12, 2012.
Application No. 13/712,563 is a continuation-in-part of application No. 13/156,999, filed on Jun. 9, 2011.
Application No. 13/712,563 is a continuation-in-part of application No. 13/296,619, filed on Nov. 15, 2011.
Application No. 13/296,619 is a continuation-in-part of application No. 14/278,223, filed on May 15, 2014.
Application No. 14/278,223 is a continuation-in-part of application No. 13/712,563, filed on Dec. 12, 2012.
Application No. 13/712,563 is a continuation-in-part of application No. 13/156,999, filed on Jun. 9, 2011.
Application No. 13/712,563 is a continuation-in-part of application No. 13/296,619, filed on Nov. 15, 2011.
Application No. 14/278,223 is a continuation-in-part of application No. 13/156,999, filed on Jun. 9, 2011.
Application No. 14/278,223 is a continuation-in-part of application No. 13/966,619, filed on Aug. 14, 2013.
Application No. 13/966,619 is a continuation-in-part of application No. 14/103,536, filed on Dec. 11, 2013.
Application No. 14/103,536 is a continuation-in-part of application No. 13/712,563, filed on Dec. 12, 2012.
Application No. 13/712,563 is a continuation-in-part of application No. 13/156,999, filed on Jun. 9, 2011.
Application No. 13/712,563 is a continuation-in-part of application No. 13/296,619, filed on Nov. 15, 2011.
(60) Provisional application No. 61/833,509, filed on Jun. 11, 2013.
(60) Provisional application No. 61/487,831, filed on May 19, 2011.
(60) Provisional application No. 61/468,095, filed on Mar. 28, 2011.
(60) Provisional application No. 61/354,022, filed on Jun. 11, 2010.
(60) Provisional application No. 61/653,562, filed on May 31, 2012.
(60) Provisional application No. 61/468,095, filed on Mar. 28, 2011.
(60) Provisional application No. 61/354,022, filed on Jun. 11, 2010.
(60) Provisional application No. 61/468,095, filed on Mar. 28, 2011.
(60) Provisional application No. 61/354,022, filed on Jun. 11, 2010.
(60) Provisional application No. 61/822,376, filed on May 12, 2013.
(60) Provisional application No. 61/653,562, filed on May 31, 2012.
(60) Provisional application No. 61/468,095, filed on Mar. 28, 2011.
(60) Provisional application No. 61/354,022, filed on Jun. 11, 2010.
(60) Provisional application No. 61/826,047, filed on May 22, 2013.
(60) Provisional application No. 61/653,562, filed on May 31, 2012.
(60) Provisional application No. 61/468,095, filed on Mar. 28, 2011.
(60) Provisional application No. 61/354,022, filed on Jun. 11, 2010.
(60) Provisional application No. 61/468,095, filed on Mar. 28, 2011.
(60) Provisional application No. 61/354,022, filed on Jun. 11, 2010.
(60) Provisional application No. 61/822,376, filed on May 12, 2013.
(60) Provisional application No. 61/653,562, filed on May 31, 2012.
(60) Provisional application No. 61/468,095, filed on Mar. 28, 2011.
(60) Provisional application No. 61/354,022, filed on Jun. 11, 2010.

(51) Int. Cl. G06F 17/30

(52) U.S. Cl. CPC G06F 17/30528; G06F 17/30867
USPC 707/706; 707/771

(57) ABSTRACT

A method and system for customizing a user query in order to receive optimized search results respective of the query are provided. The method includes determining a user intent of at least one query received from a user device; selecting at least one source from a plurality of sources of information for serving the user intent; classifying the received at least one query based on the determined user intent; customizing the query to optimally serve the user intent respective of the classification and the determined user intent; and sending the customized query to the selected at least one source, wherein each of the selected at least one source receives an appropriately customized query format.

### CROSS-REFERENCE TO RELATED APPLICATIONS

This application claims the benefit of U.S. Provisional Application No. 61/833,509 filed on Jun. 11, 2013, the contents of which are hereby incorporated by reference. This application is a continuation-in-part (CIP) of:

(a) U.S. patent application Ser. No. 13/474,404 filed on May 17, 2012, now pending. The Ser. No. 13/474,404 application claims priority from U.S. Provisional Patent Applications Nos. 61/487,831 filed May 19, 2011, 61/468,095 filed Mar. 28, 2011, and 61/354,022 filed Jun. 11, 2010. The Ser. No. 13/474,404 application is also a continuation-in-part of below-mentioned U.S. patent application Ser. No. 13/156,999;

(b) U.S. patent application Ser. No. 13/712,563 filed on Dec. 12, 2012, now pending. The Ser. No. 13/712,563 application claims the benefit of U.S. Provisional Patent Application Nos. 61/653,562 filed on May 31, 2012, 61/468,095 filed Mar. 28, 2011, and 61/354,022 filed Jun. 11, 2010. The Ser. No. 13/712,563 application is also a continuation-in-part of the below-mentioned U.S. patent application Ser. Nos. 13/156,999 and 13/296,619;

(c) U.S. patent application Ser. No. 13/156,999 filed on Jun. 9, 2011, now pending. The Ser. No. 13/156,999 application claims the benefit of U.S. Provisional Patent Application No. 61/468,095 filed Mar. 28, 2011 and U.S. Provisional Application No. 61/354,022 filed Jun. 11, 2010;

(d) U.S. patent application Ser. No. 13/296,619 filed on Nov. 15, 2011, now pending;

(e) U.S. patent application Ser. No. 14/103,536 filed on Dec. 11, 2013, now pending, which claims priority from U.S. Provisional Patent Application No. 61/822,376 filed on May 12, 2013. The Ser. No. 14/103,536 application is also a continuation-in-part of above-mentioned U.S. patent application Ser. No. 13/712,563; and

(f) U.S. patent application Ser. No. 14/278,223 filed on May 15, 2014, now pending, which claims priority from U.S. Provisional Patent Application No. 61/826,047 filed on May 22, 2013. The Ser. No. 14/278,223 application is also a continuation of the above-mentioned U.S. patent application Ser. No. 13/712,563, U.S. patent application Ser. No. 13/156,999, U.S. patent application Ser. No. 13/296,619, and U.S. patent application Ser. No. 14/103,536.

All of the applications referenced above are herein incorporated by reference.

### TECHNICAL FIELD

The present invention relates generally to search engines utilized to provide one or more search results respective of a query received from a user and, more particularly, to systems and methods for transforming a query respective of a user's intent.

### BACKGROUND

Search engines are used for searching for information over the World Wide Web (WWW). A web search query refers to a query that a user enters into a web search engine in order to receive search results. As the WWW continues to grow in size, the task of finding relevant and pertinent information to a user's search query becomes increasingly complex. Not only do users expect answers to their search queries to be returned instantaneously, they also expect that the top answers returned relate specifically to what they are searching for.

Additionally, some applications utilized to provide responses to queries may be more suitable for providing appropriate responses according to a user intent. Applications may include, but are not limited to, the Wikipedia® website, the IMDB® web application, the ESPN® application in sport related matters, the Amazon® shopping application, applications that enable local search through a user device contact list, and so on. The Wikipedia® website, for example, may be particularly appropriate to providing general information on a variety of subjects. The IMDB® and ESPN® applications, although also capable of providing information, provide more specialized information in the form of film related information and sports related information, respectively. In contrast, the Amazon® application would not be appropriate if the user intent was to seek information related to film or sports. Rather, the Amazon® application is typically appropriate when a user intent is to purchase an item.

A query received from a user device may be explicit or implicit in different levels. An implicit query makes it complicated to provide appropriate search results to the user because the user intent is unclear. As an example, if the user's query is “Madonna clips,” it is unclear whether the user is interested in listening to music clips recorded by the entertainer Madonna, viewing video clips featuring Madonna, or downloading Madonna's music or video clips to the user's device.

It would therefore be advantageous to provide a solution that would overcome the deficiencies of the prior art by customizing of a user query respective of the user intent in order to optimize search results respective thereto.

### SUMMARY

Certain exemplary embodiments include a method and system for customizing a user query. The method comprises determining a user intent of at least one query received from a user device; selecting at least one source from a plurality of sources of information for serving the user intent; classifying the received at least one query based on the determined user intent; customizing the query to optimally serve the user intent respective of the classification and the determined user intent; and sending the customized query to the selected at least one source, wherein each of the selected at least one source receives an appropriately customized query format.

Certain exemplary embodiments include a method and system for customizing sources of information providing search results respective of a user search intent. The system comprises determining the user search intent based on the received at least one query; selecting at least one source from a plurality of sources of information for serving the user intent; classifying the at least one query based on the determined intent; and customizing the at least one source to optimally serve the user intent respective of the classification.

### BRIEF DESCRIPTION OF THE DRAWINGS

The subject matter disclosed herein is particularly pointed out and distinctly claimed in the claims at the conclusion of the specification. The foregoing and other objects, features, and advantages of the invention will be apparent from the following detailed description taken in conjunction with the accompanying drawings.

FIG. 1 is a schematic diagram illustrating operation of a system for optimization of search results respective of a user's intent according to an embodiment;

FIG. 2 is a schematic block diagram of exemplary applications' categories according to an embodiment;

FIG. 3 is a flowchart illustrating indexing of applications according to an embodiment;

FIG. 4 is a flowchart illustrating providing appropriate applications to queries based on a user intent according to an embodiment;

FIG. 5 is a flowchart illustrating customization of queries based on the user search intent according to an embodiment;

FIG. 6 is a flowchart illustrating customization of sources based on the user search intent according to an embodiment; and

FIG. 7 illustrates the analysis of metadata according to one embodiment.

### DETAILED DESCRIPTION

It is important to note that the embodiments disclosed herein are only examples of the many advantageous uses of the innovative teachings herein. In general, statements made in the specification of the present application do not necessarily limit any of the various claimed inventions. Moreover, some statements may apply to some inventive features but not to others. In general, unless otherwise indicated, singular elements may be in plural and vice versa with no loss of generality. In the drawings, like numerals refer to like parts through several views.

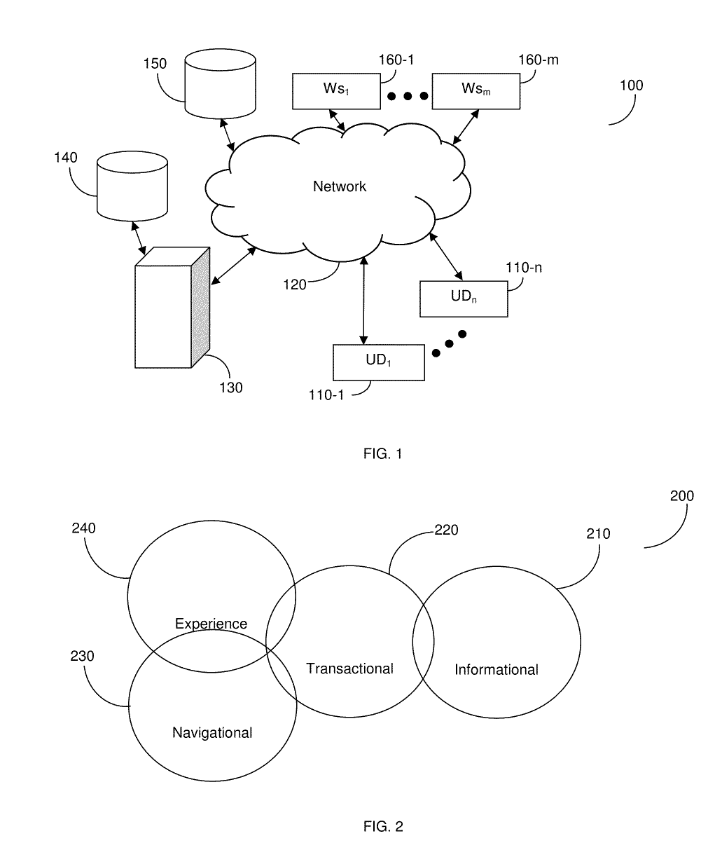

FIG. 1 depicts an exemplary and non-limiting schematic diagram of a system 100 utilized for describing various embodiments. A plurality of user devices 110-1 through 110-n (collectively referred hereinafter as user devices 110 or individually as a user device 110, merely for simplicity purposes) are connected to a network 120. A user device 110 may be, but is not limited to, a personal computer (PC), a laptop, a tablet computer, a mobile phone, a smart phone, and the like. The network 120 may be, but is not limited to, a local area network (LAN), a wide area network (WAN), a metro area network (MAN), the world wide web (WWW), the Internet, a wired network, a wireless network, and the like, as well as any combination thereof.

The user devices 110 are configured to submit queries to a server 130 which is also connected to the network 120. The server 130 is configured to send the received queries to and from an intent detection unit (IDU) 140. The IDU 140 is configured to determine the user's intent respective of a query or part of a query received from the user through the user device 110 as further described in co-pending U.S. patent application Ser. No. 14/103,536 filed on Dec. 11, 2013, assigned to common assignee and which is hereby incorporated by reference for all that it contains. The user intent represents the type of content, the content, and/or any actions that may be of an interest to the user for a current time period. The user intent is the search intent of the user. For example, if the query is Sushi, the intent may be a search for a nearby Sushi restaurant or a Sushi recipe. The determined user's intent is sent to the server 130. The IDU 140 may be realized in a server system, in a machine implemented in a cloud-computing infrastructure, a dedicated system, and the like.

The system 100 may further include a database 150 for storing information such as previously determined user search intents, prior queries received from a user, data for enhancing the search experience, customized queries, applications' classifications, and so on. A plurality of web sources 160-1 through 160-m (collectively referred hereinafter as web sources 160 or individually as a web source 160, merely for simplicity purposes) are further connected to the network 120.

The web sources 160 may include “cloud-based” applications; that is, applications executed by servers in a cloud-computing infrastructure, such as, but not limited to, a private-cloud, a public-cloud, or any combination thereof. The cloud-computing infrastructure is typically realized through a data center.

Applications are also installed on the user devices 110. The server 130 is configured to crawl through the applications that exist in the web sources 160 as well as through applications installed on the user devices 110. According to certain embodiments, the server 130 generates metadata respective of the applications. Such metadata may be, but is not limited to, the name of the application, the application bundle name, the application description, the application score, a portion thereof, a combination thereof, and so on. In such embodiments, the metadata is then analyzed by the server 130 and the applications are classified to a plurality of functional categories, where each category serves a different topic of user intents.

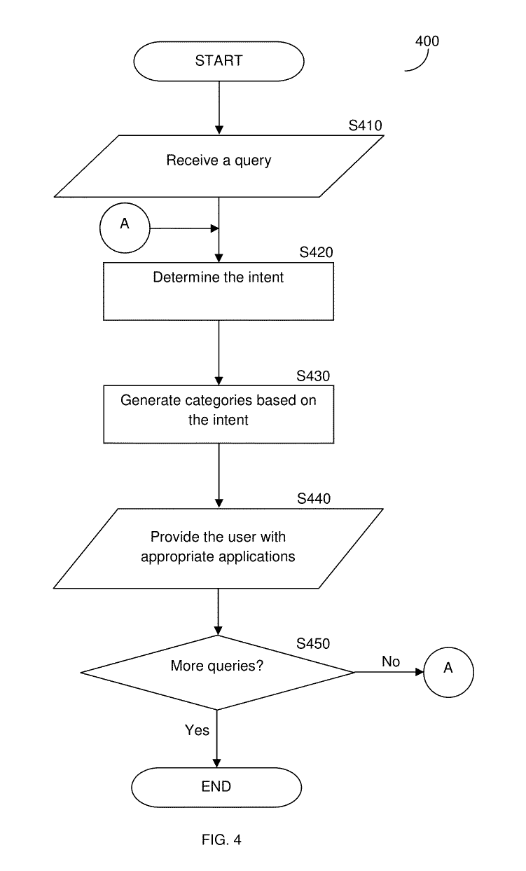

According to another embodiment, one or more additional categories may be dynamically generated respective of user intents as further described herein below with respect of FIGS. 2 and 4. In that embodiment, the applications' classification is stored in the database 150 for further use. According to one embodiment, upon receiving a query from a user through a user device 110, the IDU 140 is configured to determine the user intent. The system then selects the appropriate one or more categories respective of the user's intent and provides the appropriate sources within the category to the user device 110. Determination of user intent is discussed further herein below with respect to FIG. 4.

In certain embodiments, an agent may be installed locally on each user device 110. The agent is configured to enable a local crawling of a search through the content of the user devices 110. The various elements of the system 100 are further described in co-pending U.S. patent application Ser. No. 13/156,999 filed on Jun. 9, 2011 to Kasterstein, et al., assigned to common assignee, which is hereby incorporated by reference for all that it contains.

FIG. 2 depicts an exemplary and non-limiting schematic block diagram 200 of exemplary query categories according to an embodiment. By analyzing the query and determining the user intent, one or more appropriate applications may be matched respective of one or more query categories. As an example, applications may include, but are not limited to, the Wikipedia® website, the IMDB® web application, the ESPN® application in sport related matters, applications that enable local search through the user device 110 contact list, and so. Informational category 210 generally includes one or more queries that include a specific question. As an example, such an informational category query may be “Who won the NBA championship in 2003?”

A transactional category 220 typically includes one or more queries that require additional actions following the execution of a corresponding one or more applications in order to be appropriately served. As a non-limiting example, such additional actions may include playing a video within a video stream website, purchasing tickets through a ticket purchasing application, and so on. Examples for such applications are YouTube® application, Ticketmaster® website, just to name a few.

According to one embodiment, the applications that are determined as appropriate to serve queries classified as belonging to the transactional category 220 may be provided with one or more search results respective of the query. As a non-limiting example, if the query received is “watch Madonna's new video clip,” the stream of the new Madonna's video clip may be provided to the user device 110 through the YouTube® application rather than through the YouTube® main web page.

A navigational category 230 typically includes one or more queries that specifically mention the name and/or the functionality required by the user. The one or more queries classified to the navigational category 230 often explicitly indicate the user intent. An example for such a query may be, but is not limited to, “PDF reader,” “scanner,” and the like. Applications determined as appropriate to serve various types of queries classified to the navigational category 230 may be, for example, photos galleries, alarm clock applications, and so on.

According to another embodiment, an experience category 240 may also be determined based on the user intent. An experience category 240 typically includes queries that define the user's desired experience in some capacity. A user's desired experience may be defined with respect to, but is not limited to, length of time required to view or listen to search results, price of search results (for purchase related queries), video or audio quality of search results (e.g., 1080p for a video search result), word count of an article returned as a search result, and so on. The experience category may include, for example, queries such as “free games.” The user intent based on such query is determined as games with $0 prices and, therefore, the server 130 provides such games to the user device 110.

A person of ordinary skill in the art would readily appreciate that the queries described in FIG. 2 may be clustered without departing from the embodiments disclosed herein and therefore several applications may be included in several categories.

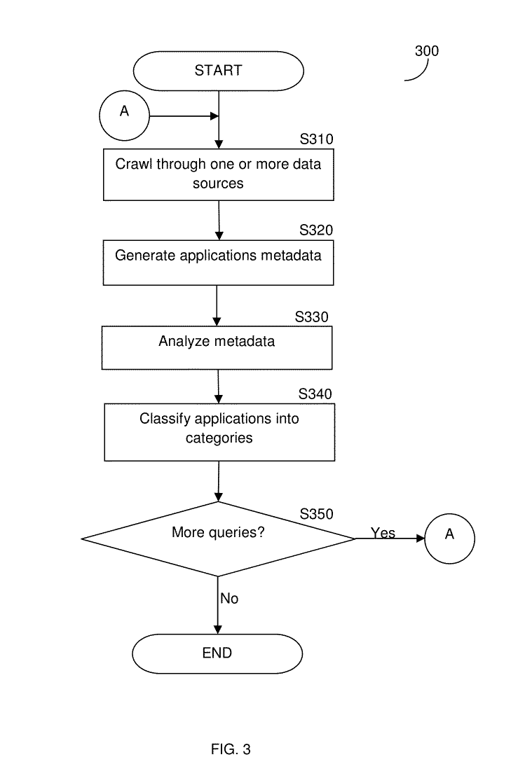

In various embodiments, a query may be classified into more than one category. In yet another embodiment, if a query cannot be classified into at least one category, a list of similar suggested queries that can be classified into one or more categories may be provided to the user. Such similar suggested queries may be stored in a database (e.g., database 150). Queries may be considered similar if they have one or more words in common, contain words that relate to similar subject matter (e.g., the words “football” and “basketball” are both related to sports), and so on. Queries may be suggested if they exhibit a high degree of similarity (in a non-limiting and exemplary embodiment, a high degree of similarity may exist where two or more queries contain three or more words in common), if the selected appropriate sources indicate that such queries are frequently made by other users, and so on. Selection of appropriate sources is discussed further herein below with respect to FIG. 3.

FIG. 3 depicts an exemplary and non-limiting flowchart 300 of a method for indexing applications according to one embodiment. In an embodiment, a server (e.g., server 130) may perform the steps of the method disclosed herein. In S310, one or more data sources are crawled through to identify applications. In the embodiment described with respect to FIG. 1, a data source may be any one of the user devices 110, the web sources 160, the database 150, or any combination thereof.

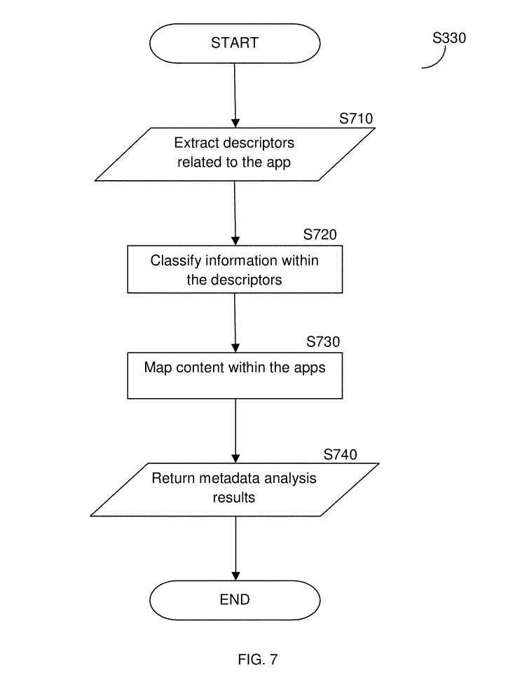

In S320, metadata is generated respective of the identified applications. Such metadata may be, but is not limited to, the name of the application, the application bundle name, the application description, the application score, and so on. In S330, the metadata is analyzed. Analysis of metadata is discussed further herein below with respect to FIG. 7. In S340, based on the analysis of the metadata, the identified applications are classified into one or more query categories as further described hereinabove with respect to FIG. 2. As a non-limiting example, if the analyzed application is Ticketmaster® movie ticket services, generated metadata may include a description indicating that the application allows users to purchase movie tickets. Based on the metadata, the Ticketmaster® application is classified into the transactional category. In S350, it is checked whether additional requests to index applications have been received and, if so, execution continues with S310; otherwise, execution terminates.

FIG. 4 depicts an exemplary and non-limiting flowchart 400 of a method for providing appropriate applications to queries based on the user intent according to one embodiment. In S410, a query or portion thereof is received. In an embodiment, the query is received from a user device such as, for example, the user device 110. In S420, the user intent is determined. In an embodiment, the user intent is determined by an IDU (e.g., the IDU 140). User intent may be determined based on, but is not limited to, the presence and/or absence of words and punctuation in the query such as, e.g., the presence of a question mark that may indicate that the user's intent is to seek information, the presence of the word “buy” that may indicate that the user wishes to purchase one or more of the other search terms, and so on.

In an embodiment where the user intent is implicit rather than explicit (that is, the query will not serve the user intent if entered before customization), the user intent may also be determined based on one or more personal and/or environmental variables related to the user. A personal variable may be, but is not limited to, a user profile, demographic information, user preferences, and so on. An environmental variable may be, for example and not by way of limitation, the location of the user mobile device, the device rate of motion, time of day, and more. Utilization of personal variables to determine user intent is discussed further in the above-referenced U.S. patent application Ser. No. 13/712,563, assigned to common assignee, which is hereby incorporated by reference for all that it contains.

As a non-limiting example, if the time is 8 A.M. on Monday and the user's device location is the user's home, then the intent associated with the search term “news” may be related to “review news from newsfeeds and/or newspapers,” which would represent a general intent regarding news. If the location changes to away-from-home, and the GPS information indicates the user is driving, the intent may be changed to “receive traffic updates,” which represents more specific news that is particularly relevant to the user's current actions. As another example, if the device's motion is determined to be at a rate of a person walking, the search term is “map,” and the location is determined as 5^{th} Avenue in New York City, the user intent may be to “find nearby shopping stores.”

In S430, respective of the determined intent, the query is classified into one or more categories. As a non-limiting example, if the user's query included the word “buy,” the user intent may be determined to be to purchase goods. In that example, the query would then be classified into the transactional category based on the determined user intent, since purchases will typically involve further interaction by the user.

In S440, one or more applications are classified into one or more categories. Classification of applications into categories is discussed further herein above with respect to FIG. 3. Applications that are classified into the same category as the query are determined to be appropriate applications. In S450, the one or more appropriate applications are provided. In S460, it is checked whether additional requests have been received and, if so, execution continues with S420; otherwise, execution terminates.

A person of ordinary skill in the art would readily appreciate that the operation of the method for indexing applications as described in FIG. 3 and the operation of providing appropriate applications to queries based on the user search intent as described in FIG. 4 may be integrated without departing from the scope of the disclosed embodiments.

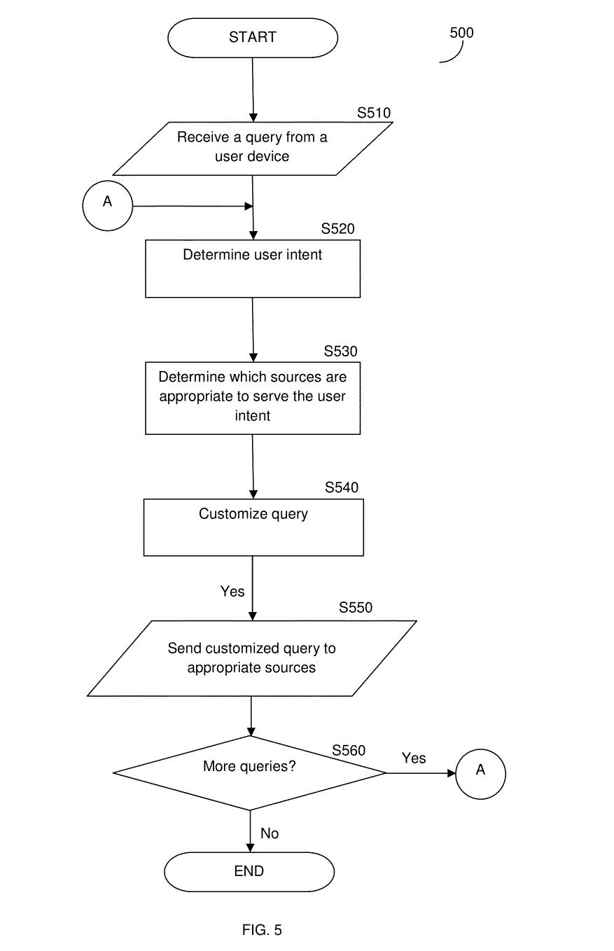

FIG. 5 depicts an exemplary and non-limiting flowchart 500 of a method for customizing queries based on the user intent according to one embodiment. In S510, a query or a portion thereof is received. In an embodiment, the query may be received from a user device such as, for example the user device 110. The query may be, for example, a keyword, a portion of a keyword, a plurality of keywords, a character, a series of characters, and the like. In one embodiment, at least a portion of a query is automatically completed and at least a query is suggested based on, for example, a user experience.

In S520, the user intent is determined. In an embodiment, this determination is made by an IDU (e.g., the IDU 140). According to another embodiment, the query may be implicit. In such cases where the query is implicit, at least a variable, environmental or personal, is received and the user intent is determined respective thereto. Determination of user intent respective of a variable is further described in above-referenced U.S. patent application Ser. No. 13/712,563.

In S530, based on the user intent, one or more sources are determined as appropriate to serve the user intent. Appropriate sources may be, but are not limited to, the user devices 110, applications that are installed on the user devices 110, the web sources 160, the database 150, or a combination thereof. A source may be determined as appropriate if, e.g., the source has an application installed on it that shares a classification with the query, the source is associated with metadata indicating that the source would deal with the query's category (for example, metadata indicating that a user may buy goods through the source for a transactional query to buy an item), and so on. Classification of applications into categories is discussed further herein above with respect to FIG. 3.

In S540, the query is customized in order to optimally serve the user intent. The customization process may include, but is not limited to, removing one or more parameters from the query, adding one or more parameters to the query, and replacing one or more parameters within the query. Customization of a query may also involve transforming the query from an input to be put into a search engine to a URL of a web-page. As a non-limiting example, the query “Kobe Bryant” may be determined to be related to a user intent to learn general knowledge about basketball player Kobe Bryant. In this example, the query “Kobe Bryant” may be transformed to: “http://www.nba.com/lakers/profiles/1314_bryant.” In an embodiment, the customized query may be further customized such that the query meets one or more input parameters of the selected appropriate sources. As a non-limiting example, if a source requires that all inputs be at least three letters in length (such that the words “and,” “the,” “it,” and so on. will not be recognized by the source), customization may include removing any words that are shorter than three letters in length.

In S550, the customized query is sent to the selected appropriate sources. In an embodiment, metadata may be provided respective of the query sent to the selected appropriate sources, and the metadata may further include information about the geo-location of the user, so the sources can provide location-based results. For example, but without limitations, if a user is searching for Sushi, all the sources may get the location of the user so they can provide restaurants and offers nearby the user's physical vicinity. In S560, it is determined whether additional queries have been received and, if so, execution continues with S520; otherwise, execution terminates.

As a non-limiting example utilizing the system 100 of the embodiment described in FIG. 1, the query “Bryant” is received by a user device 110. The user experience extracted from the database 150 indicates that the user commonly visits basketball websites and, therefore, that the user intent is to obtain information related to Kobe Bryant, the Los Angeles Lakers Basketball player. The query is determined as related to the informational category 210. Respective thereto, the ESPN® website is determined as an appropriate source to serve the user intent. Then, the query is customized to the query “Basketball Kobe Bryant information.” The query customization is based on input requirements of the ESPN® website as well as the categorized intent (i.e., the category of the intent is an informational category and the intent relates to basketball player Kobe Bryant). The customized query is then provided as a search query to the webpage within the ESPN® website, where information related to athletes is shown.

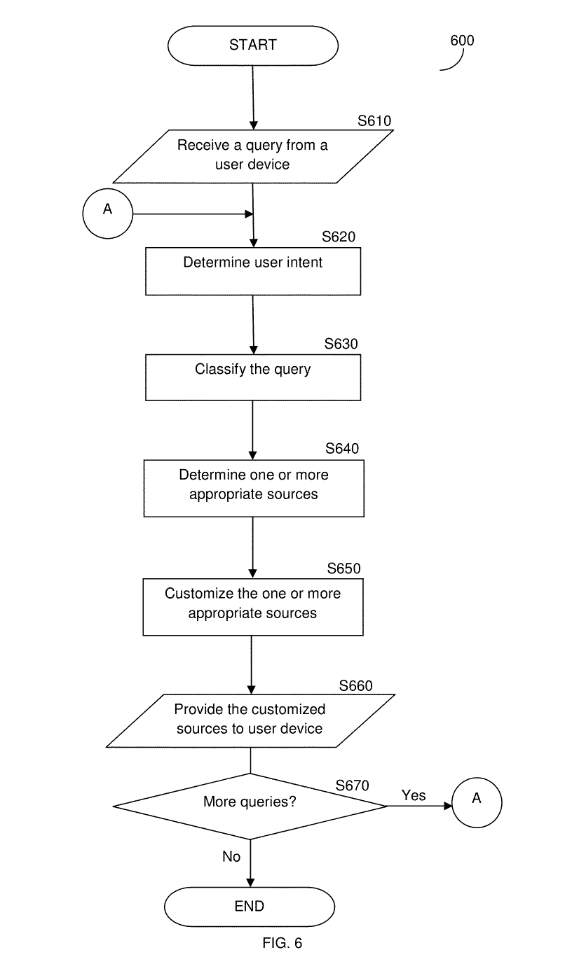

FIG. 6 depicts an exemplary and non-limiting flowchart 600 of a method for customizing sources in order to optimally serve user intents according to one embodiment. In S610, a query, or a portion thereof is received, either explicitly or implicitly. In an embodiment, the query is received from a user device such as, for example, the user device 110. In S620, the user intent is determined. In an exemplary embodiment, this determination is made by the IDU 140. Determination of user intent is discussed further herein above with respect to FIG. 4.

In S630, based on the determined user intent, the query is classified into one or more categories. Classification of queries into categories is further described hereinabove with respect of FIG. 4. In S640, one or more sources are determined as appropriate to serve the one or more categories. Sources are determined as appropriate to serve one or more categories of queries if the sources are classified into one or more of the categories that the query is classified into.

In S650, the one or more appropriate sources are customized in order to optimally serve the user intent. The customization may include, for example, an analysis of the one or more sources, extraction of one or more identifiers of the one or more sources the source identifiers, customization of the source identifiers, and so on. A source identifier may be, for example, the uniform resource locator (URL) of a website. It should be noted that in various websites' implementation the search query is embedded in the URL. Thus, customizing the URL equivalent to customizing the query. In S660, the one or more customized sources are provided to the user device 110. In S670, it is checked whether there are additional queries and, if so, execution continues with S620; otherwise, execution terminates.

As a non-limiting example, the query “Air Jordan” is received by a user device such as, for example, the user device 110. The intent of the user is determined to be “purchasing Air Jordan shoes.” Respective thereto, the query is classified into transactional category 220. A webpage within the Amazon® website is determined as appropriate to serve the user intent. The URL of the webpage within the Amazon® website is identified as http://www.amazon.com/?q={query}&type={type}. The server 130 then customizes the URL of the selected source through which the term “query” within the URL is replaced with the term “air Jordan” and the term “type” within the URL is replaced with word “shoes”. The customized query, http://www.amazon.com/?q={air jordan}&type={shoes}, is then provided to the user device 110 respective thereto.

FIG. 7 depicts an exemplary and non-limiting flowchart S330 illustrating analysis of metadata according to an embodiment. In S710, descriptors related to the application and/or to the applications context (e.g., tags, etc.) are extracted from the metadata. Such descriptors may be related to, but are not limited to, the terms in the description, the volume of terms in the description, the location of the application in a repository, the rank of the application, and so on.

In S720, potentially classifying information within the extracted descriptors is identified. Such potentially classifying information may include, but is not limited to, certain terms in the description (e.g., the term “purchase” may be used to classify an application as falling into the transactional category), a location in a repository associated with one or more classifications, rank of an application used to determine which application would likely be best for the user, and so on. This information may later be used to perform classification of the application.

In S730, content within the application is mapped. In an embodiment, mapping may involve determining which web-pages the application links to. In S740, the metadata analysis results are returned.

As a non-limiting example, metadata related to the Amazon® shopping application is received. The metadata includes descriptors indicating that users can purchase items through the application, and that the goods to be purchased have descriptions demonstrating the features of each good. The words “purchase” and “description” are identified as potentially classifying information due to their relevance to the transactional category and the informational category, respectively. Content of the Amazon application is mapped. Several listings on the application feature URLs to external web-pages, which are determined during mapping.

The various embodiments disclosed herein can be implemented as hardware, firmware, software, or any combination thereof. Moreover, the software is preferably implemented as an application program tangibly embodied on a program storage unit or computer readable medium consisting of parts, or of certain devices and/or a combination of devices. The application program may be uploaded to, and executed by, a machine comprising any suitable architecture. Preferably, the machine is implemented on a computer platform having hardware such as one or more central processing units (“CPUs”), a memory, and input/output interfaces. The computer platform may also include an operating system and microinstruction code. The various processes and functions described herein may be either part of the microinstruction code or part of the application program, or any combination thereof, which may be executed by a CPU, whether or not such a computer or processor is explicitly shown. In addition, various other peripheral units may be connected to the computer platform such as an additional data storage unit and a printing unit. Furthermore, a non-transitory computer readable medium is any computer readable medium except for a transitory propagating signal.

All examples and conditional language recited herein are intended for pedagogical purposes to aid the reader in understanding the disclosed embodiments and the concepts contributed by the inventor to furthering the art, and are to be construed as being without limitation to such specifically recited examples and conditions. Moreover, all statements herein reciting principles, aspects, and embodiments of the invention, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

What is claimed is:

1. A method for customizing a user query, comprising:
determining a user intent of at least one query received from a user device;
selecting at least one source from a plurality of sources of information for serving the user intent;
classifying the received at least one query based on the determined user intent;
customizing the query to optimally serve the user intent respective of the classification and the determined user intent; and
sending the customized query to the selected at least one source, wherein each of the selected at least one source receives an appropriately customized query format.

2. The method of claim 1, wherein the at least one query is implicit.

3. The method of claim 2, wherein determination of the user intent further comprises:
receiving at least one environmental variable; and
determining the user intent respective of the at least one received environmental variable.

4. The method of claim 3, further comprising:
receiving at least one personal variable; and
determining the user intent based on the least one personal variable.

5. The method of claim 2, wherein the determination of the user intent further comprises:
tokenizing the at least one query to at least one token;
providing the at least one token to a plurality of engines, wherein each engine of the plurality of engines is configured to handle at least one different topic of interest;
receiving from the plurality of engines at least one possible user intent and a certainty score for each of the at least one possible user intent generated by the plurality of engines responsive of receipt of the at least one token;
analyzing the certainty score of each of the at least one possible user intent; and
determining the user intent based on the analysis of the certainty score of the at least one possible user intent.

6. The method of claim 1, wherein the query is any one of: a free text query, and a structured query.

7. The method of claim 1, wherein the customization further comprises at least one of: adding at least one parameter to the at least one query, replacing at least one parameter received as the at least one query, and removing at least one parameter received as the at least one query.

8. The method of claim 6, wherein the structured query comprises at least a field that contains a term that is provided to a corresponding field of the at least one selected source.

9. The method of claim 1, further comprising:
providing an input query that is customized to meet an input requirement of the selected at least one source respective of the user intent.

10. A non-transitory computer readable medium having stored thereon instructions for causing at least one processing unit to execute the method according to claim 1.

11. A method for customizing sources of information providing search results respective of a user search intent, comprising:
determining the user search intent based on the received at least one query;
selecting at least one source from a plurality of sources of information for serving the user intent;
classifying the at least one query based on the determined intent; and
customizing the at least one source to optimally serve the user intent respective of the classification.

12. The method of claim 11, wherein the at least one query is implicit.

13. The method of claim 12, wherein the determination of the user intent further comprises:
receiving at least one environmental variable; and
determining the user intent respective of the at least one environmental variable.

14. The method of claim 13, further comprising:
receiving at least one personal variable; and
determining the user intent based on the least one personal variable.

15. The method of claim 12, wherein the determination of the user intent further comprises:
tokenizing the at least one query to at least one token;
providing the at least one token to a plurality of engines, wherein each engine of the plurality of engines is configured to handle at least one different topics of interest;
receiving from the plurality of engines at least one possible user intent and a certainty score for each of the at least one possible user intent generated by the plurality of engines responsive of receipt of the at least one token;
analyzing the certainty score of each of the at least one possible user intent; and
determining the user intent based on the analysis of the certainty score of the at least one possible user intent.

16. The method of claim 11, wherein the query is one of: a free text query, and a structured query.

17. The method of claim 11, wherein the customization further comprises at least one of: analyzing the at least one source, extracting at least one identifier of the at least one source, and customizing the at least one identifier of the at least one source.

18. The method of claim 17, wherein the identifier is a uniform resource locator.

19. The method of claim 16, wherein the structured query comprises at least a field that contains a term that is provided to a corresponding field of the at least one selected source.

20. A non-transitory computer readable medium having stored thereon instructions for causing at least one processing unit to execute the method according to claim 11.

21. A system for customizing a user query, comprising:
a database containing information respective of a plurality of sources of information;
an interface to a network configured to receive and send data over the network;
a processing unit coupled to the network; and
a memory communicatively connected to the processing unit, wherein the memory contains instructions that, when executed by the processor, configure the system to:
classify the query based on the determined intent;
customize the query to optimally serve the user intent respective of the classification; and
send the customized query to the selected at least one source, wherein each of the selected at least one source receives an appropriately customized query format.

22. The system of claim 21, further configured to:
receive at least a query from a user device;
tokenize the at least one query to at least one token;
analyze the tokens;
generate at least one optional user intent respective of the tokens;
determine the user intent; and
provide at least one appropriate application to the user device respective of the user intent.

23. The system of claim 21, wherein the system is further configured to:
receive at least one environmental variable; and
determine the user intent respective of the at least one environmental variable.

24. The system of claim 23, wherein the system is further configured to:
receive at least one personal variable; and
determine the user intent based on the least one personal variable.

25. The system of claim 21, wherein the query is one of: a free text query, and a structured query.

26. The system of claim 21, wherein the customization further comprises at least one of: adding at least one parameter to the at least one query, replacing at least one parameter received as the at least one query, and removing at least one parameter received as the at least one query.

27. The system of claim 25, wherein the structured query comprises at least a field that contains a term that is provided to a corresponding field of the at least one selected source.

28. The system of claim 21, the system is further configured to: provide an input query that is customized to meet an input requirement of the selected at least one source respective of the user intent.
